(19) United States
(12) Patent Application Publication
(10) Pub. No.: US 2023/0386084 A1
(43) Pub. Date: Nov. 30, 2023

(54) Apparatus for calibrating a three-dimensional position of a centre of an entrance pupil of a camera, calibration method therefor, and system for determining relative positions of centres of entrance pupils of at least two cameras mounted on a common supporting frame to each other, and determination method therefor

(71) Applicant: Tripleye GmbH, Karlsruhe (DE)

(72) Inventors: Jens SCHICK, Herrenberg (DE); Michael SCHARRER, Karlsruhe (DE)

(73) Assignee: Tripleye GmbH, Karlsruhe (DE)

(21) Appl. No.: 18/027,666

(22) PCT Filed: Sep. 28, 2021
(86) PCT No.: PCT/EP2021/076560

§ 371 Date: Mar. 22, 2023

(30) Foreign Application Priority Data
Sep. 29, 2020 (DE) 10 2020 212 279.2

(51) Int. Cl. G06T 7/80

(52) U.S. Cl. CPC G06T 7/85; G06T 2207/10028; G06T 2207/30204

(57) ABSTRACT

An apparatus serves to calibrate a three-dimensional position of a center of an entrance pupil of a camera. The apparatus comprises a mount for holding the camera in such a manner that it captures a predetermined calibration field of view. At least two stationary reference cameras serve to capture the calibration field of view from different directions. The apparatus has at least one stationary main calibration surface arranged in the calibration field of view with stationary main calibration structures. The apparatus further has at least one additional calibration surface with additional calibration structures, driven to be displaceable between a neutral position and an operating position in the field of view. An evaluation unit serves to process recorded camera data of the camera to be calibrated and of the reference cameras and status parameters of the apparatus. This results in an apparatus with which cameras can be precisely calibrated with regard to the three-dimensional position of their entrance pupil center.

### CROSS-REFERENCES TO RELATED APPLICATIONS

This application claims the priority of German Patent Application, Serial No. DE 10 2020 212 10 279.2, filed Sep. 29, 2020, the content of which is incorporated herein by reference in its entirety as if fully set forth herein.

### FIELD OF THE INVENTION

The invention relates to an apparatus for calibrating a three-dimensional position of a center of an entrance pupil of a camera. The invention further relates to a method for calibrating a three-dimensional position of a center of an entrance pupil of a camera by means of such an apparatus. The invention further relates to a system for determining relative positions of centers of entrance pupils of at least two cameras mounted on a common supporting frame. Furthermore, the invention relates to a method for determining relative positions of centers of entrance pupils of at least two cameras using such a system.

### BACKGROUND OF THE INVENTION

An object detection apparatus is known from WO 2013/020872 A1 and the references given therein. US 2019/0 212 139 A1 describes tools and methods for 3D calibration. US 2011/0 026 014 A1 discloses methods and systems for calibrating an adjustable lens. DE 10 2018 108 042 A1 discloses an optical measurement system comprising a calibration apparatus. DE 10 2010 062 696 A1 discloses a method and an apparatus for calibrating and adjusting a vehicle environment sensor.

### SUMMARY OF THE INVENTION

It is an object of the present invention to precisely calibrate cameras, which can be used in particular for such object detection apparatuses, with respect to the three-dimensional position of their entrance pupil center, i.e. to calibrate these cameras intrinsically, i.e. with respect to properties of the camera itself, in particular with respect to camera imaging properties and imaging errors, and possibly also extrinsically, i.e. with respect to the position of the camera relative to the camera environment.

This object is achieved according to the invention by an apparatus for calibrating a three-dimensional position of a center of an entrance pupil of a camera, comprising a mount for holding the camera in such a manner that the latter captures a predetermined calibration field of view, comprising at least two stationary reference cameras for recording the calibration field of view from different directions, comprising at least one stationary main calibration surface having stationary main calibration structures that are arranged in the calibration field of view, comprising at least one additional calibration surface which has additional calibration structures which driven to be displaceable between a neutral position in which the additional calibration surface is arranged outside the field of view, and an operating position in which the additional calibration surface is arranged within the field of view, via a calibration surface displacement drive, comprising an evaluation unit for processing recorded camera data of the camera to be calibrated and of the reference cameras and status parameters of the apparatus.

A position calibration of the entrance pupil center can be performed in all three spatial directions. The calibration field of view can be so large that cameras with an aperture angle that is larger than 180°, i.e. in particular fisheye cameras, can also be calibrated. The parameter to be calibrated “center of camera entrance pupil” is equivalent to the parameter “center of projection” in the terminology of epipolar geometry.

An additional parameter of the apparatus that can be processed by the evaluation unit is a position of the additional calibration surface, for example, whether the additional calibration surface is in the neutral position or in the operating position.

By determining the three-dimensional position of the center of the entrance pupil, the calibration apparatus allows the resulting determination of a distortion vector field. Such a distortion vector field indicates for any point in space to be imaged by the camera to be calibrated by which distortion vector this point is shifted relative to an ideally imaged point in space (distortion error). Via the distortion vector field, on the one hand, an intrinsic calibration of the camera to be calibrated is possible, i.e. a calibration of its imaging properties, as well as an extrinsic calibration, i.e. a determination of the position of the camera relative to its environment. The camera or cameras to be calibrated intrinsically and/or extrinsically can be a camera bundle that is mounted on a common camera support.

The calibration apparatus can be used to achieve a position determination accuracy that is better than one camera pixel and can also be better than 0.8 camera pixel, than 0.6 camera pixel, than 0.4 camera pixel, than 0.2 camera pixel and even better than 0.1 camera pixel. In particular, a distortion error can be determined with an accuracy that is better than 0.1 camera pixel.

An absolute position detection accuracy of the position of the entrance pupil center of the camera to be calibrated can be better than 0.2 mm. A detection of the center of the entrance pupil of the camera to be calibrated can also be carried out in a dimension perpendicular to the pupil plane.

The main and/or the additional calibration structures can be provided with a regular pattern, for example arranged in the form of a grid. The calibration structures can contain colored pattern elements and/or coded pattern elements, for example QR codes or barcodes. The camera to be calibrated may be a single camera, may be a stereo camera or may be a camera group comprising a larger number of cameras. A baseline of such a stereo camera, i.e. a distance between the individual cameras of the stereo camera and/or a direction characterizing the positional relationship of the two cameras of the stereo camera to each other, or baselines of pairs of cameras of the camera group may then be a parameter that is to be calibrated as well. Calibration may take place in an environment where distortion optics, for example a vehicle windscreen, are located between the camera to be calibrated and the calibration structures. Calibration with the aid of the calibration apparatus may take place within a product manufacturing line, for example within a motor vehicle manufacturing line.

The calibration surfaces can be in the form of calibration panels that are carrying calibration structures. These calibration panels can be flat or in the form of a surface that is located three-dimensionally in space. Corresponding calibration panels may be connected to each other in such a manner that there is a fixed, predetermined angle between two calibration panels. At least two of the calibration panels can also be hinged together so that a predefinable angle can be set between the calibration panels. More than two such calibration panels can be connected to each other at a fixed predetermined angle and/or at an adjustable angle.

The calibration surfaces can represent side surfaces of calibration bodies, for example the side surfaces of a calibration cube.

At least one of the calibration surfaces used may be designed such that it moves during the performance of a calibration method with the calibration apparatus.

The shape as well as the pattern of the calibration structures of the calibration surfaces is known and is stored in a correspondingly digitized form in a memory of the calibration apparatus.

The calibration structures may be multispectral calibration structures. Accordingly, the calibration structures can signal a texture in different spectral channels. The calibration structures can therefore be displayed differently for different illumination or scanning colors.

The calibration structures can be designed as single point structures.

The calibration structures can be designed as a patterns of single points. Such a pattern can have randomly distributed single points, wherein the pattern formed by this does not have a distinguished symmetry plane and/or symmetry axis.

The calibration structures can have structure and/or texture elements. From these elements, an unambiguous assignment of the respective calibration structure or a calibration component equipped therewith can be obtained when viewing with different cameras. Such structure and/or texture elements can contain scaling information. Such scaling information can also be obtained from a base distance of the cameras under consideration or from a distance of a camera under consideration to the respective calibration structure.

The stationary reference cameras may be fixedly mounted on a supporting frame of the apparatus and are in particular fixedly mounted relative to the mount for holding the camera to be calibrated.

Image capture directions of the stationary reference cameras can intersect at one point. If there are more than two stationary reference cameras, their image capture directions may intersect at the same point.

In an apparatus comprising at least one further reference camera, which is movable relative to the mount, for recording the calibration field of view, which is driven to be displaceable between a first field of view recording position and at least one further field-of-view recording position that differs from the first field-of-view recording position in an image capture direction, via a camera displacement drive, the position determination accuracy during calibration is further improved. The respective position of the movable reference camera is considered as the status parameter to be processed. The field-of-view recording positions of the movable reference camera can differ in the pitch angle and/or the yaw angle of the movable reference camera. A considered reference point of the moving reference camera on the main calibration surface can be the same point.

Additional calibration structures of the respective additional calibration surface in 3D arrangement that deviates from a flat surface lead to a further improvement of the calibration result. The additional calibration structures of the respective additional calibration surface can be in a bowl-shaped arrangement in which sloping wall sections then extend from a central “bottom” portion to an edge of the additional calibration surface.

The foregoing advantage applies correspondingly to main calibration structures which are arranged in a main calibration structure main plane and additionally in a main calibration structure angular plane, wherein the main calibration structure angular plane is arranged at an angle greater than 5° to the main calibration structure main plane. The angle at which the main calibration structure planes are arranged may be greater than 10°, may be greater than 20°, may be greater than 30°, may be greater than 45°, may be greater than 60°, may be greater than 75° and may be, for example, 90°. There may be more than two main calibration structure surfaces in the different main calibration structure planes.

The advantages of a method for calibrating a three-dimensional position of a center of an entrance pupil of a camera by means of an apparatus, comprising the steps of holding the camera to be calibrated in the mount, capturing the stationary main calibration surface with the camera to be calibrated and the reference cameras with the additional calibration surface in the neutral position, displacing the additional calibration surface between the neutral position and the operating position with the calibration surface displacement drive, capturing the additional calibration structures with the camera to be calibrated and the reference cameras with the additional calibration surface in the operating position and evaluating the recorded image data of the camera to be calibrated and the reference cameras with the evaluation unit correspond to those already explained above with reference to the calibration apparatus. An evaluation of the recorded image data can be carried out via a vector analysis of the recorded image data considering the positions of the recorded structures.

In a method comprising the calibration apparatus described above and comprising the further steps of capturing the main calibration surface and/or the additional calibration surface with the movable reference camera in the first field of view recording position, displacing the movable reference camera with the camera displacement drive, capturing the main calibration surface and/or the additional calibration surface with the movable reference camera in the further field of view recording position, and evaluating the recorded image data of the movable reference camera with the evaluation unit, the advantages of the movable reference camera take effect particularly well. In the calibration method using the movable reference camera, for example, the main calibration surface can first be captured in a first relative position of the movable reference camera, wherein the additional calibration surface is present in the neutral position, then the additional calibration surface can be displaced into the operating position and the additional calibration structures can then be measured in the same relative position of the movable reference camera. Subsequently, the movable reference camera can be moved to a further field-of-view recording position and first the additional calibration structures can be measured with the additional calibration surface remaining in the operating position. Finally, the additional calibration surface is displaced to the neutral position and the main calibration surface is now measured with the movable reference camera remaining in the further field-of-view recording position.

In the calibration method, the calibration surfaces can be illuminated with illumination light with different spectral components. From this, a chromatic aberration of involved optical components of the calibration apparatus can be concluded. A relative position of individual cameras of a twin or multi-camera system with individual cameras that are sensitive to different colors is also possible.

It is another object of the invention to improve a position determination of entrance pupil centers of at least two cameras which are mounted on a common supporting frame, for example a camera arrangement according to WO 2013/020872 A1.

This object is achieved according to the invention by a system for determining relative positions of centers of entrance pupils of at least two cameras which are mounted on a common supporting frame with respect to each other, comprising a plurality of calibration structure carrier components comprising calibration structures that can be arranged around the supporting frame such that each of the cameras detects at least calibration structures of two of the calibration structure carrier components, wherein the arrangement of the calibration structure carrier components is such that at least one of the calibration structures of one and the same calibration structure carrier component is captured by two cameras and comprising an evaluation unit for processing recorded camera data of the cameras.

The system is very flexible due to the possible free relative arrangement of the calibration structure carrier components. The arrangement of the calibration structure carrier components in such a manner that each of the cameras detects at least calibration structures of two of the calibration structure carrier components, wherein in addition at least one of the calibration structures or a group of calibration structures of one and the same calibration structure carrier component is detected by two cameras, leads to a precise determinability of the relative positions of the entrance pupil centers of these cameras.

The evaluation unit can also process status parameters of the apparatus, for example a respective position of the supporting frame to the calibration structure carrier components.

Advantages of the determination method for determining relative positions of centers of entrance pupils of at least two cameras using a system, comprising the steps of mounting the cameras on the common supporting frame, arranging the calibration structure carrier components as a group of calibration structure carrier components around the supporting frame, capturing the calibration structure carrier components that are located in the field of view of the cameras in a predetermined relative position of the supporting frame to the group of calibration structure carrier components and evaluating the recorded image data of the cameras with the evaluation unit correspond initially to those of the system. In the arrangement step of the determination method, the calibration structure carrier components may be positioned around the supporting frame. Alternatively, a group of calibration structure carrier components may be pre-positioned and the supporting frame may then be introduced in this group. Mixed forms of these two basic arrangement variants are also possible. The determination method can be carried out with cameras that have previously undergone the calibration method explained above. The calibration structure carrier components may be freely positionable. A floor on which the calibration structure carrier components are positioned may be uneven. The calibration structures of the calibration structure carrier components may be designed as explained above in connection with the main and/or additional calibration structures of the calibration apparatus. In the evaluation, in the determination method, camera relative position results that have been obtained by capturing the calibration structures of a calibration structure carrier component may be compared with each other, and therefrom a best-fit of the relative camera positions to be determined may be obtained. From the determined relative positions, the camera positions in the coordinate system of the supporting frame can be concluded by considering target nominal positions of the cameras relative to the supporting frame.

In the method comprising the further steps of displacing the supporting frame in such a manner that at least one of the cameras captures a calibration structure carrier component which has not been previously detected by this camera, repeating the capturing and displacement until each of the cameras has captured at least calibration structures of two of the calibration structure carrier components, wherein calibration structures of at least one of the calibration structure carrier components have been captured by two cameras, a particularly exact relative position determination of the entrance pupil centers of the at least two cameras is obtained. Alternatively, capturing and displacing can also be performed in such a manner that at least the same calibration structure of at least one of the calibration structure carrier components has been captured in adjacent cameras in each case, so that a concatenation of the acquired image data is possible via adjacent cameras in each case. It is therefore not mandatory that each of the cameras has captured calibration structures of at least two calibration structure carrier components. A displacement of the supporting frame can take place, for example, via a vehicle movement of a vehicle to which the supporting frame belongs.

Master structures for specifying a coordinate system of the relative positions to be determined simplify the specification of a master coordinate system in which the relative position determination is initially carried out.

In the determination method, the calibration structure carrier components may be aligned with nominal arrangement components whose position and location in space is known. Such nominal components may be fixedly installed cameras of the system or fixedly installed calibration structure carrier components. Alignment may also be performed to linear guidance coordinates of movable calibration structure carrier components and/or the movable supporting frame.

The method could use moving calibration structure carrier components.

In the context of the method, a method for determining a distance of a camera from a calibration structure based on a distance of two adjacent cameras (baseline) may be used, in particular a triangulation method. Such a distance can be measured with the aid of a laser distance sensor.

The apparatuses and methods described above as well as the system can also be combined with each other and can also be implemented with a different combination of the described features. For example, it is possible to combine the apparatus for calibration with the system for relative position determination and/or to combine the described methods. With the system, after appropriate upgrading, it is also possible in principle to use a calibration method which has been explained above in connection with the calibration apparatus. For this purpose, the system can be upgraded, for example, by an additional, movable reference camera.

Examples of embodiments of the invention are explained in more detail below with reference to the drawing.

### BRIEF DESCRIPTION OF THE DRAWING

FIG. 1 shows a top view onto an apparatus for calibrating a three-dimensional position of a center of an entrance pupil of a camera, wherein an additional calibration surface is shown both in a neutral position outside a camera field of view and in an operating position in the camera field of view;

FIG. 2 shows a view from direction II in FIG. 1 with additional calibration surfaces in the neutral position;

FIG. 3 shows a schematic representation to illustrate positional relationships between components of the calibration apparatus;

FIG. 4 shows a further detail view of a movable reference camera of the calibration apparatus including a camera displacement drive for moving the movable reference camera in multiple translational/rotational degrees of freedom;

FIG. 5 schematically shows different orientations of the movable reference camera, namely a total of eight orientation variants;

FIG. 6 shows a calibration panel with a calibration surface, comprising calibration structures, which can be used as main calibration surface and/or as additional calibration surface in the calibration apparatus;

FIG. 7 in a view from above, shows an arrangement of a system for determining relative positions of centers of entrance pupils of at least two cameras that are mounted on a common supporting frame;

FIG. 8 schematically shows two cameras of a stereo camera for capturing three-dimensional images, wherein coordinates and position parameters for determining angular correction values of the cameras to each other are illustrated;

FIG. 9 again schematically shows the two cameras of the stereo camera according to FIG. 8 capturing scene objects of a three-dimensional scene, wherein position deviation parameters of characteristic signatures of the images captured by the cameras are highlighted;

FIG. 10 shows a block diagram to illustrate a method for capturing three-dimensional images with the aid of the stereo camera according to FIGS. 8 and 9;

FIG. 11 shows an apparatus for carrying out a method for producing a redundant image of a measurement object using, for example, two groups of three cameras each that are assigned to a common signal processing;

FIG. 12 in a representation similar to FIG. 6, shows a further embodiment of a calibration panel with calibration structures;

FIG. 13 also in a top view, shows a further embodiment of a calibration panel, designed as a plate target with two interconnected calibration structure carrier components in the form of calibration panels according to FIG. 12, the panel planes of which have a known angle to each other;

FIG. 14 shows a view of the plate target according to FIG. 13 from viewing direction XIV, wherein a camera that is directed at this plate target is also shown;

FIG. 15 shows a calibration structure carrier component configured as a cube; and

FIG. 16 shows a top view onto a manufacturing line comprising an arrangement of calibration panels with calibration structures that is adapted to an assembly line run.

### DESCRIPTION OF THE PREFERRED EMBODIMENTS

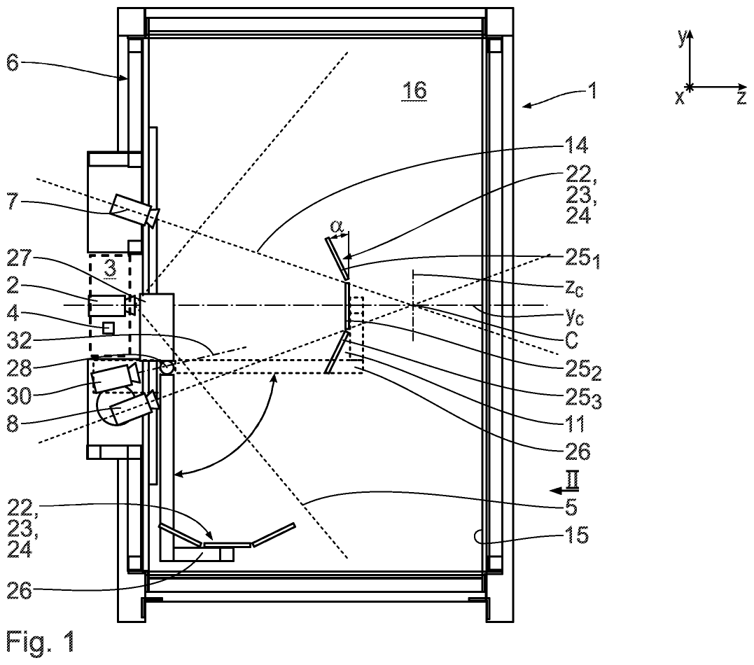

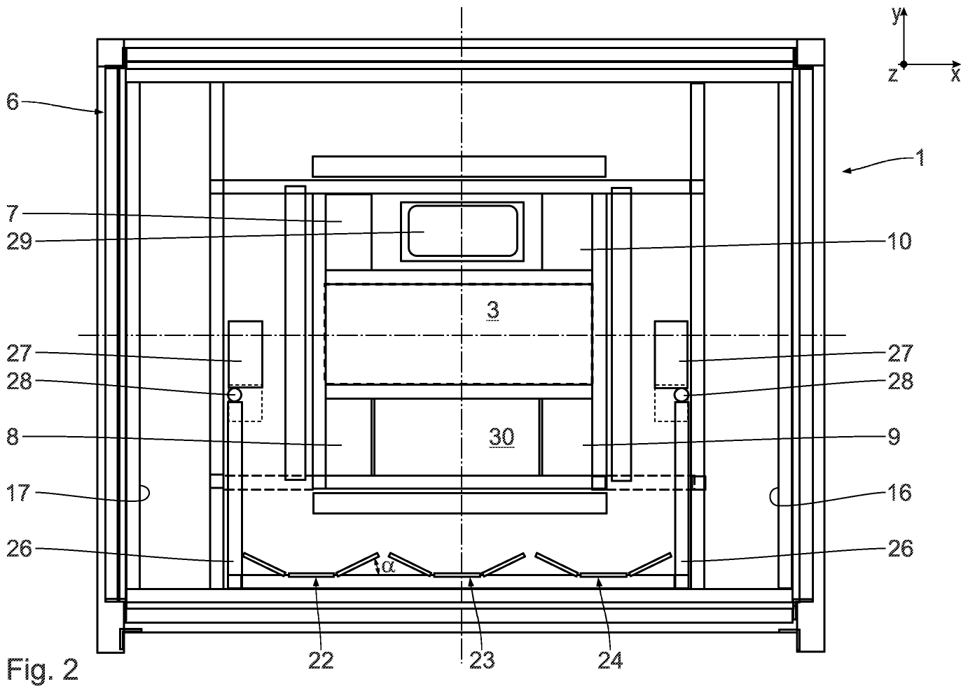

A calibration apparatus 1 serves to calibrate a three-dimensional position of a center of an entrance pupil of a camera 2 that is to be calibrated. The camera 2 to be calibrated is arranged within a cuboid mounting volume 3, which is highlighted by dashed lines in FIGS. 1 and 2. The camera 2 to be calibrated is firmly mounted within the mounting volume 3 when the calibration procedure is carried out. A mount 4, which is merely implied in FIG. 1, serves for this purpose.

The camera 2 to be calibrated is held by the mount 4 in such a manner that the camera 2 covers a predetermined calibration field of view 5, the boundaries of which are shown in dashed lines in the side view of the apparatus 1 according to FIG. 1.

The camera 2 to be calibrated may, for example, be a camera for a vehicle that is to be used to provide an “autonomous driving” function.

Depending on the embodiment of the calibration apparatus 1, at least one mounting volume of the type of the mounting volume 3 can be provided, which is provided for receiving and correspondingly calibrating a plurality of cameras to be calibrated. This plurality for calibrating the cameras can be calibrated simultaneously.

To facilitate the description of positional relationships, in particular of cameras of the apparatus 1 to each other and to the field of view 5, an xyz coordinate system is drawn in each of the FIGS. 1 to 3, unless otherwise indicated. In FIG. 1, the x-axis runs perpendicular to the drawing plane and into it. The y-axis runs upwards in FIG. 1. The z-axis runs to the right in FIG. 1. In FIG. 2, the x-axis runs to the right, the y-axis runs upwards and the z-axis runs out of the drawing plane perpendicular to the drawing plane.

An entire viewing range of the calibration field of view 5 can cover a detection angle of 100° in the xz plane, for example. Other detection angles between, for example, 10° and 180° are also possible. In principle, it is also possible to calibrate cameras with a detection angle that is greater than 180°.

The mount 4 is fixed to a supporting frame 6 of the calibration apparatus 1.

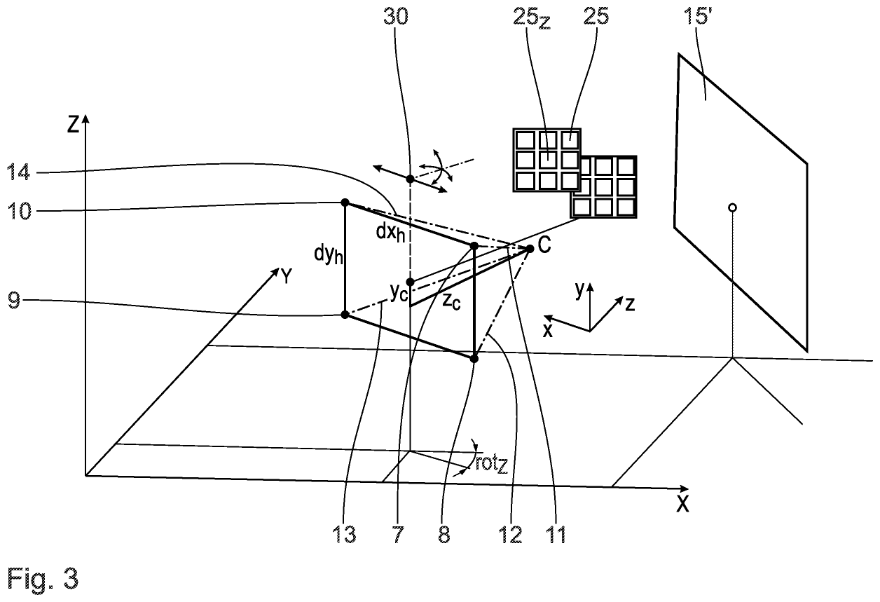

The calibration apparatus 1 has at least two and, in the version shown, a total of four stationary reference cameras 7, 8, 9 and 10 (cf. FIG. 3), of which only two stationary reference cameras, namely reference cameras 7 and 8, are visible in FIG. 1. The stationary reference cameras 7 to are also mounted on the supporting frame 6. The stationary reference cameras 7 to 10 serve to record the calibration field of view 5 from different directions. A larger number of reference cameras used within the calibration apparatus 1 is also possible.

The reference cameras 7 to 10 can be camera systems in which individual cameras with different lenses are used, for example with a telephoto lens and with a fisheye lens. Such camera systems with individual cameras having different lenses, in particular with different focal lengths, are also referred to as twin cameras if two individual cameras are used.

FIG. 3 shows exemplary dimensional parameters that play a role in the calibration apparatus 1.

Main lines of sight 11, 12, 13, 14 of the stationary reference cameras 7 to 10 are shown in dash-dotted lines in FIG. 3.

These main sight lines 11 to 14 intersect at a point C (cf. FIGS. 1 and 3). The coordinates of this intersection point C are marked x_{c}, y_{c} and z_{c} in FIGS. 1 and 3.

An x-distance between the reference cameras 7 and 10, on the one hand, and the reference cameras 8 and 9, on the other hand, is indicated in FIG. 3 with dxₕ. An x-coordinate of the stationary reference cameras 7 and 8, on the one hand, and 9 and 10, on the other hand, is the same in each case.

A y-distance between the stationary reference cameras 7 and 8, on the one hand, and 9 and 10, on the other hand, is marked with dyₕ in FIG. 3. A y-coordinate of the stationary reference cameras 7 and 10, on the one hand, and 8 and 9, on the other hand, is the same in each case.

The calibration apparatus 1 further has at least one stationary main calibration surface, in the illustrated embodiment example three main calibration surfaces 15, 16 and 17, which are specified by corresponding calibration panels. The main calibration surface 15, in the arrangement according to FIGS. 1 and 2, extends parallel to the xy-plane and at a z-coordinate which is greater than z_{c}. The two further, lateral main calibration surfaces 16, 17, in the arrangement according to FIGS. 1 and 2, extend parallel to the yz-plane on both sides of the arrangement of the four stationary reference cameras 7 to 10. The main calibration surfaces 15 to 17 are also mounted to be stationary on the supporting frame 6.

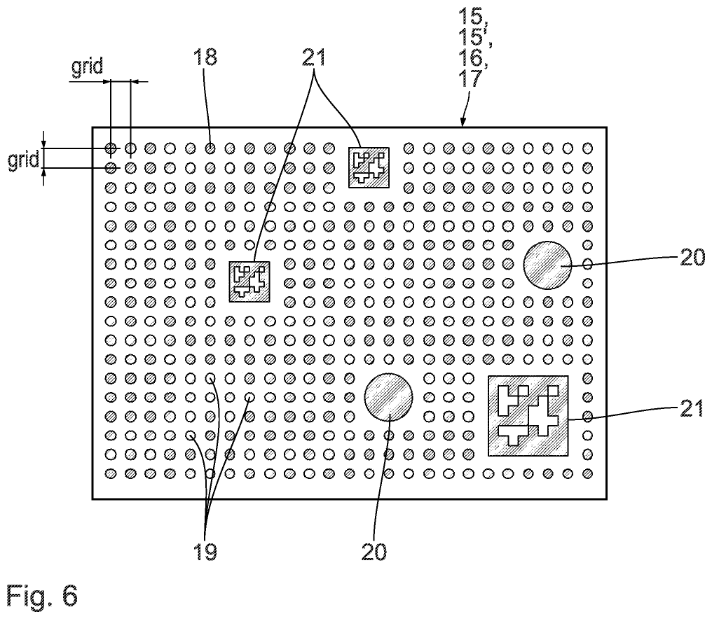

The main calibration surfaces have stationary main calibration structures, examples of which are shown in FIG. 6. At least some of these calibration structures are arranged in the calibration field of view 5. The main calibration structures can have a regular pattern, for example arranged in the form of a grid. Corresponding grid points which are part of the calibration structures are shown in FIG. 6 at 18. The calibration structures may have colored pattern elements, as illustrated in FIG. 6 at 19. Furthermore, the calibration structures may have different sizes. Pattern elements that are enlarged compared to the grid points 18 are highlighted in FIG. 6 at 20 as main calibration structures. Furthermore, the main calibration structures may comprise coded pattern elements, for example QR codes 21 (cf. FIG. 6).

An arrangement of the main calibration surfaces 15 to 17 aligned to the xyz coordinate system according to FIGS. 1 and 2 is not mandatory. FIG. 3 shows an exemplarily tilted arrangement of a main calibration surface 15′, which for example has an angle to the xy-plane.

FIG. 3 also shows an external XYZ coordinate system, for example of a production hall, in which the calibration apparatus 1 is housed. The xyz coordinate system of the coordinate system of the calibration apparatus 1, on the one hand, and the XYZ coordinate system of the production hall, on the other hand, can be tilted against each other, as illustrated in FIG. 3 by a tilt angle rot_{z}.

The main calibration structures 15 to 17, 15′ are thus present in a main calibration structure main plane (xy plane in the arrangement according to FIGS. 1 and 2) and additionally in a main calibration structure angular plane (yz plane in the arrangement according to FIGS. 1 and 2), wherein the main calibration structure main plane xy is arranged at an angle greater than 5°, namely at an angle of 90°, to the main calibration structure angular plane yz. This angle to the main calibration structure angular plane yz may be greater than 10°, may be greater than 20°, may be greater than 30°, may be greater than 45° and may also be greater than 60°, depending on the embodiment. Small angles, for example in the range between 1° and 10°, can be used to approximate a curved calibration structure surface with the main calibration structures. In the arrangement according to FIGS. 1 and 2 and additionally in the arrangement of the main calibration surface 15′ according to FIG. 3, more than two main calibration structure surfaces 15 to 17, 15′ may be arranged in different main calibration structure planes.

A position of the respective main calibration surface, for example the main calibration surface 15′ in comparison to the xyz coordinate system can be defined via a position of a center of the main calibration surface as well as two tilt angles of the main calibration surface 15′ to the xyz coordinates. A further parameter characterizing each of the main calibration surfaces 15 to 17 or 15′ is a grid spacing grid of the grid points 18 of the calibration structure, which grid spacing is illustrated in FIG. 6. The two grid values, which are given horizontally and vertically for the main calibration surface 15′ in FIG. 6, do not necessarily have to be equal to each other, but they must be fixed and known.

Also, the positions of the colored pattern elements 19, the enlarged pattern elements 20 and/or the coded pattern elements 21 within the grid of the grid points 18 is fixed in each case for the main calibration surface 15 to 17, 15′. These positional relationships of the various pattern elements 18 to 21 to each other serve to identify the respective main calibration surface, to determine the absolute position of the respective main calibration surface in space. The enlarged pattern elements 20 can be used to support the respective position determination. Different sizes of the pattern elements 18 to 20 and also of the coded pattern elements 21 enable a calibration measurement in the near and in the far range as well as also a measurement in which the main calibration surfaces 15 to 17, 15′ are, if necessary, strongly tilted with respect to the xy-plane.

Furthermore, the calibration apparatus 1 has at least one and, in the embodiment shown, three additional calibration surfaces 22, 23 and 24 comprising additional calibration structures 25. The additional calibration surfaces 22 to 24 are implemented by shell-shaped calibration panels. The additional calibration structures 25 are in each case arranged on the additional calibration surface 22 to 24 in the form of a 3×3 grid. The additional calibration structures 25 can in turn each have pattern elements of the type of the pattern elements 18 to 21 explained above in connection with the main calibration surfaces.

The additional calibration surfaces 22 to 24 are mounted together on a movable holding arm 26. The latter can be swiveled about a swivel axis 28, which runs parallel to the x-direction, via a geared motor 27, i.e. a calibration surface displacement drive. Via the geared motor 27, the additional calibration structures 22 to 24 can be displaced between a neutral position and an operating position. The neutral position of the additional calibration structures 22 to 24, in which they are arranged outside the calibration field of view 5, is shown solid in FIGS. 1 and 2. Dashed in FIG. 1 is shown an operating position of the holding arm 26 and the additional calibration surfaces 22 to 24 which operating position is swiveled upwards in comparison to the neutral position. In the operating position, the additional calibration surfaces 22 to 24 are arranged in the calibration field of view 5.

In the operating position, a central additional calibration structure 25_{Z} (cf. also FIG. 3) is located parallel to the xy-plane, for example, as shown in FIGS. 1 and 2. The 3×3 grid arrangement of the additional calibration structures 25 is then located in the operating position in three rows 25₁, 25₂ and 25₃ that run along the x-direction and in three columns that run parallel to the y-direction. In each case adjacent rows and in each case adjacent columns of the additional calibration structures 25 are tilted relative to each other by a tilt angle α, which can fall within the range between 5° and 45°, for example within the range of 30°. For the four grid areas that are each arranged in the corners of the 3×3 grid, this tilting by the tilt angle α is present about two axes that are perpendicular to each other. This results in the shell-shaped basic structure of the respective additional calibration surface 22 to 24. The additional calibration structures 25 are present in a 3D arrangement that deviates from a flat surface.

The calibration apparatus 1 further includes an evaluation unit 29 for processing recorded camera data of the camera 2 to be calibrated as well as of the stationary reference cameras 7 to 10 as well as status parameters of the apparatus, i.e. in particular the position of the additional calibration surfaces 22 to 24 as well as of the main calibration surfaces 15 to 17 as well as positions and line-of-sight curves of the reference cameras 7 to 10. The evaluation unit 29 may have a memory for image data.

The calibration apparatus 1 also includes a movable reference camera 30, which also serves to record the calibration field of view 5.

FIG. 3 illustrates degrees of freedom of movement of the movable reference camera 30, namely two tilt degrees of freedom and one translational degree of freedom.

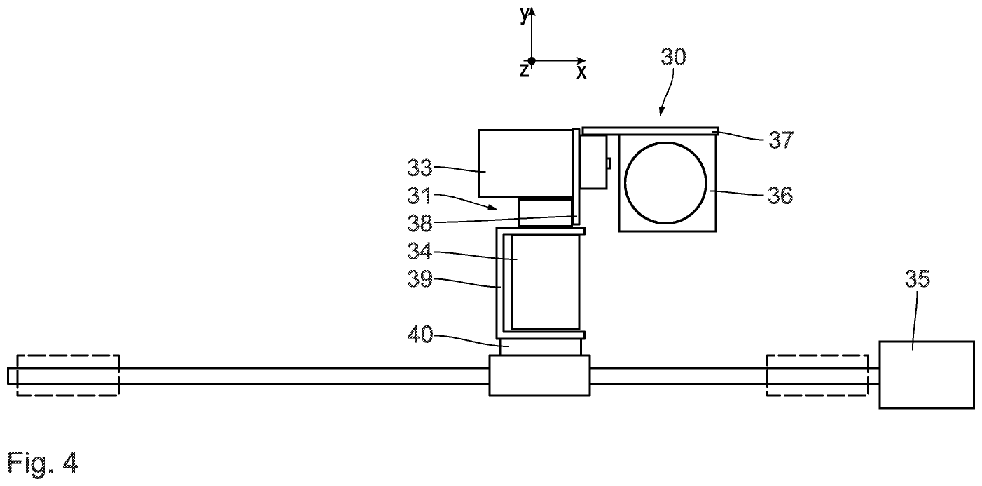

FIG. 4 shows details of the movable reference camera 30. The latter can be displaced by means of a camera displacement drive 31 between a first field-of-view recording position and at least one further field-of-view recording position, which differs from the first field-of-view recording position in an image capture direction (cf. recording direction 32 in FIG. 1).

The camera displacement drive 31 includes a first swivel motor 33, a second swivel motor 34 and a linear displacement motor 35. A camera head 36 of the movable reference camera 30 is mounted on a swivel component of the first swivel motor 33 via a retaining plate 37. The camera head 36 can be swiveled about an axis that is parallel to the x-axis via the first swivel motor 33. The first swivel motor 33 is mounted on a swivel component of the second swivel motor 34 via a further supporting plate 38. Via the second swivel motor 34, it is possible to swivel the camera head 36 about a swivel axis that is parallel to the y-axis.

The second swivel motor 34 is mounted on a linear displacement unit 40 of the linear displacement motor 35 via a retaining bracket 39. Via the linear displacement motor 35 a linear displacement of the camera head 36 parallel to the x-axis is possible.

The camera displacement drive 31 and also the camera head 36 of the reference camera 30 are in signal connection with the evaluation unit 29. The position of the camera head 36 is precisely transmitted to the evaluation unit 29 depending on the position of the motors 33 to 35 and also depending on the mounting situation of the camera head 36 in relation to the first swivel motor 33.

The angular position of the camera head 36 that can be preset via the first swivel motor 33 is also referred to as the pitch angle. Instead of the first swivel motor 33, a change of a pitch angle can also be implemented via an articulated connection of the camera head 36 via an articulated axis that is parallel to the x-axis and a linear drive which can be displaced in the y-direction with two stops for presetting two different pitch angles and which is connected to the camera head 36. The angular position of the camera head 36 that can be preset via the second swivel motor 34 is also referred to as the yaw angle.

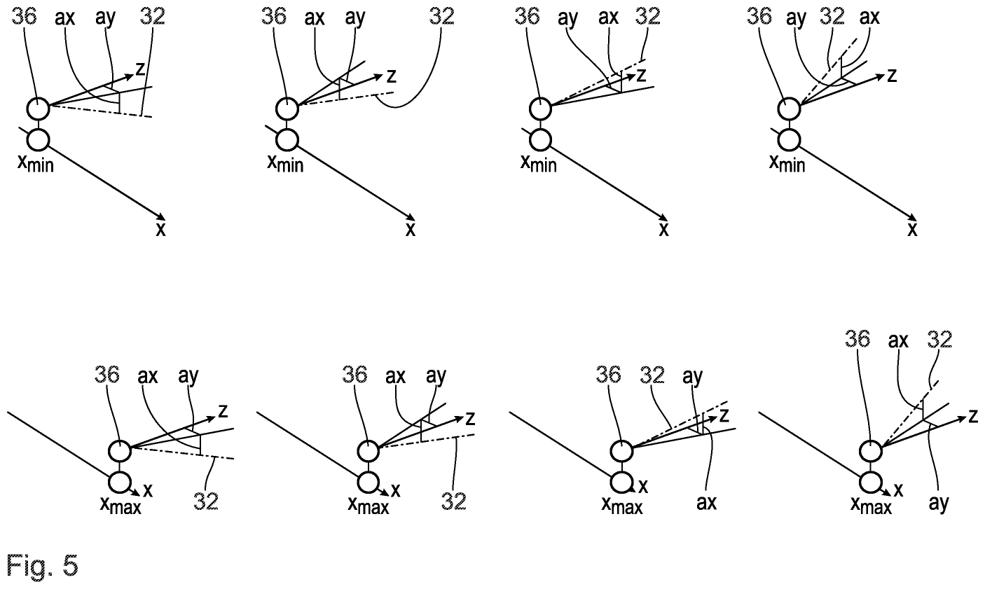

FIG. 5 illustrates an example of eight variants of positioning the camera head 36 of the movable reference camera 30 using the three degrees of freedom of movement that are illustrated in FIG. 3.

The image capture direction 32 is in each case shown dash-dotted, depending on the pitch angle ax and yaw angle ay set in each case. In the top row of FIG. 5, the camera head is provided at a small x-coordinate xₘᵢₙ. Compared thereto, in the bottom row of FIG. 5, the camera head 36 is provided at a larger x-coordinate xₘₐₓ. The eight image capture directions according to FIG. 5 represent different parameter triples (position x; ax; ay) comprising two discrete values for each of these three parameters.

In one variant of the calibration apparatus, the movable reference camera 30 can also be dispensed with.

To calibrate a three-dimensional position of a center of an entrance pupil of the camera 2 to be calibrated, the calibration apparatus 1 is used as follows:

First, the camera 2 to be calibrated is held in the mount 4.

Subsequently, the stationary main calibration surfaces 15 to 17 or 15′ are captured with the camera 2 to be calibrated and the reference cameras 7 to 10 as well as 30, wherein the additional calibration surfaces 22 to 24 are in the neutral position.

The additional calibration surfaces 22 to 24 are then displaced between the neutral position and the operating position with the calibration surface displacement drive 27. The additional calibration surfaces 22 to 24 are then captured by the camera 2 to be calibrated and by the reference cameras 7 to 10 and 30, wherein the additional calibration structures 25 are in the operating position. The recorded image data of the camera 2 to be calibrated and of the reference cameras 7 to 10 and 30 are then evaluated by the evaluation unit 29. This evaluation is carried out via a vector analysis of the recorded image data, considering the positions of the recorded calibration structures 18 to 21 as well as 25.

When the main calibration surfaces 15 to 17 and the additional calibration surfaces 22 to 24 are captured, a first capture of the main calibration surfaces 15 to 17, 15′, on the one hand, and of the additional calibration surfaces 22 to 24, on the other hand, can be performed by the movable camera 30 in the first field-of-view recording position and, after displacement of the movable reference camera 30 with the camera displacement drive 31, in the at least one further field-of-view recording position, wherein the image data of the movable reference camera 30 in the at least two field-of-view recording positions are also taken into account when evaluating the recorded image data.

A capture sequence of the calibration surfaces 15 to 17 and 22 to 24 can be as follows: First, the main calibration surfaces 15 to 17 are captured by the movable camera 30 in the first field-of-view recording position. Then the additional calibration surfaces 22 to 24 are displaced to the operating position and again captured by the movable reference camera 30 in the first field-of-view recording position. The movable reference camera 30 is then displaced into the further field-of-view recording position, wherein the additional calibration surfaces 22 to 24 remain in the operating position. Subsequently, the additional calibration surfaces 22 to 24 are captured by the movable reference camera 30 in the further field-of-view recording position. The additional calibration surfaces 22 to 24 are then moved to the neutral position and a further capture of the main calibration surfaces 15 to 17 takes place with the movable reference camera in the further field-of-view recording position. During this sequence, the main calibration surfaces 15 to 17 can also be captured by the stationary reference cameras 7 to 10 during periods in which the additional calibration surfaces 22 to 24 are in the neutral position and, if the additional calibration surfaces 22 to 24 are in the operating position, these additional calibration surfaces 22 to 24 can also be captured by the stationary reference cameras 7 to 10.

Illumination of the calibration surfaces 15 to 17, 22 to 24 can be carried out with illumination light having different spectral components. This can be used to consider a chromatic aberration of the camera 2 to be calibrated and/or the reference camera 7 to 10. When using twin cameras, for example camera systems in which at least one RGB camera and at least one IR camera are accommodated in the same housing, such multispectral illumination can be used to determine a relative position of the individual cameras to each other in the camera system. Each of the cameras can be calibrated with a camera-specific spectral illumination. In this process, parameters that are characterizing imaging errors, for example distortion parameters, as well as a position of the camera, for example with respect to at least one of the main calibration surfaces 15 to 17, are determined. If corresponding calibrations of an RGB/IR twin camera having the same main calibration surface 15 to 17 are determined, the relative position of these two individual cameras of the twin cameras can also be calculated from the two resulting positions of the RGB camera on the one hand and the IR camera on the other hand of such a twin camera.

When using camera systems comprising individual cameras having different lenses, the calibration structures of the calibration surfaces 15 to 17, 22 to 24 can have patterns of individual points of different sizes. Details of such possible patterns will be explained below in connection with a system for determining relative positions of centers of entrance pupils of at least two cameras.

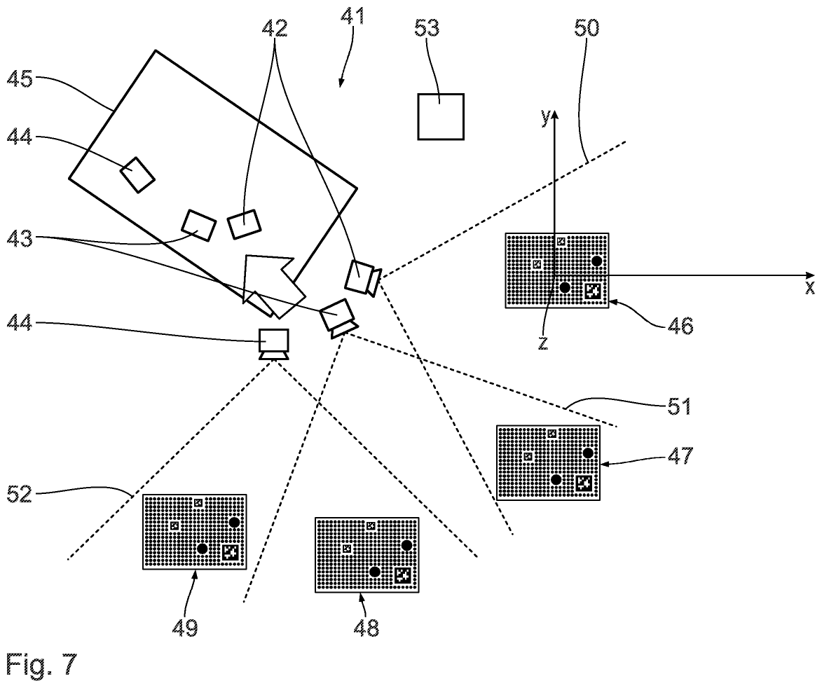

With reference to FIG. 7, a system 41 for determining mutual relative positions of centers of entrance pupils of at least two cameras 42, 43, 44 that are mounted on a common supporting frame 45 is described below.

The cameras 42 to 44 may have been calibrated in advance with regard to the position of their respective entrance pupil center with the aid of the calibration apparatus 1.

A nominal position of the cameras 42 to 44 relative to the supporting frame 45, i.e. a target installation position, is known when this relative position determination is carried out by means of the system 41.

The cameras 42 to 44 may, for example, be cameras on a vehicle to be used to provide an “autonomous driving” function.

The system 41 has a plurality of calibration structure carrier components 46, 47, 48 and 49. These calibration structure carrier components 46 to 49 are also referred to hereinafter as plate targets or as targets.

The calibration structure carrier component 46 is a master component for specifying a master coordinate system xyz. In FIG. 7, the x-axis of this master coordinate system extends to the right, the y-axis extends upward, and the z-axis extends out of the drawing plane perpendicular to the drawing plane.

For the calibration structures, which are applied to the calibration structure carrier components 46 to 49, what was explained above for the calibration structures 18 to 21 in connection in particular with FIG. 6 applies.

The calibration structure carrier components 46 to 49 are arranged around the supporting frame in an operating position of the system 41 such that each of the cameras 42 to 44 captures calibration structures of at least two of the calibration structure carrier components 46 to 49. Such an arrangement is not mandatory, so it is possible for at least some of the cameras 42 to 44 to capture calibration structures from only exactly one of the calibration structure carrier components 46 to 49. Moreover, the arrangement of the calibration structure carrier components 46 to 49 is such that at least one of the calibration structures on exactly one of the calibration structure carrier components 46 to 49 is captured by two of the cameras 42 to 44. To ensure these conditions, if necessary, the supporting frame 45 can be displaced relative to the calibration structure carrier components 46 to 49, which do not change their positions in each case.

FIG. 7 illustrates an example of the position of the supporting frame 45 with actual positions of the cameras 42, 43, 44 on the supporting frame, which is not shown again, in such a manner that a field of view 50 of the camera 42 captures the calibration structures of the calibration structure carrier components 46 and 47, while the camera 43 with its field of view 51 captures the calibration structures of the calibration structure carrier components 47 and 48 and while the further camera 44 with its field of view 52 captures the calibration structures of the calibration structure carrier components 48 and 49.

A relative position of the calibration structure carrier components 46 to 49 to each other does not have to be strictly defined in advance, but must not change during the position determination procedure by means of the system 41.

The system 41 also includes an evaluation unit 53 for processing recorded camera data from the cameras 42 to 44 and, if applicable, status parameters during the position determination, i.e. in particular an identification of the respective supporting frame 45.

To determine the relative positions of the center of the entrance pupil of the cameras 42 to 44, the system 41 is used as follows:

In a first preparatory step, the cameras 42 to 44 are mounted on the common supporting frame 45. In a further preparatory step, the calibration structure carrier components 46 to 49 are arranged as a group of calibration structure carrier components around the supporting frame 45.

This can also be done by laying out the group of calibration structure carrier components 46 to 49 in a preparatory step and then positioning the supporting frame relative to this group. In addition, the xyz coordinate system is defined via the alignment of the master component 46. The other calibration structure carrier components 47 to 49 do not have to be aligned to this xyz coordinate system.

Now the calibration structure carrier components 46 to 49 that are located in the field of view of the cameras 42 to 44 are captured in a predetermined relative position of the supporting frame 45 to the group of calibration structure carrier components 46 to 49, for example in the actual position of the cameras 42 to 44 according to FIG. 7. The recorded image data of the cameras 42 to 44 are then evaluated by the evaluation unit 53 so that the exact positions of the centers of the entrance pupils as well as the image capture directions of the cameras 42 to 44 are determined in the coordinate system of the master component 46. These actual positions are then converted into coordinates of the supporting frame 45 and matched with the nominal target positions. This can be done in the context of a best fit procedure.

In the determination process, the supporting frame can also be displaced between different camera capture positions such that at least one of the cameras whose relative position is to be determined captures a calibration structure carrier component that was not previously detected by that camera. This step of capturing and displacing the supporting frame can be repeated until, for all cameras whose relative positions to each other are to be determined, the condition is met that each of the cameras captures at least calibration structures of two of the calibration structure carrier components, wherein at least one of the calibration structures is captured by two of the cameras.

Each of the plate targets 46 to 49 has basically six positional degrees of freedom, namely three degrees of freedom of translation in the x, y and z directions and three degrees of freedom of rotation about an axis that is parallel to the x axis, parallel to the y axis or parallel to the z axis. These rotational degrees of freedom are also referred to as ax, ay and az.

When the plate targets 46 to 49 are placed on a flat surface, three of the six degrees of freedom are “trapped”, namely the degrees of freedom z (floor level) and ax and ay (plane of the floor). Therefore, the degrees of freedom x, y and az then remain for determination or estimation by means of camera detection.

A direction az can be determined with the help of a compass of the system 41, so that the two degrees of freedom x and y remain as degrees of freedom to be determined.

If the plate targets are placed along a line x=x₀, the only degree of freedom that remains is the y coordinate.

Depending on the embodiment, the plate targets 46 to 49 can also be arranged vertically displaced in relation to each other in the z-direction, so that in this case the degrees of freedom x, y, z as well as az must be regularly determined or estimated.

Other combinations of degrees of freedom that are “trapped” due to the boundary conditions and free, i.e. to be determined/estimated, are also possible depending on the embodiment of the system 41.

One of the respective plate targets 46 to 49 may be composed of two interconnected calibration structure carrier components that have a fixed and known angle to each other.

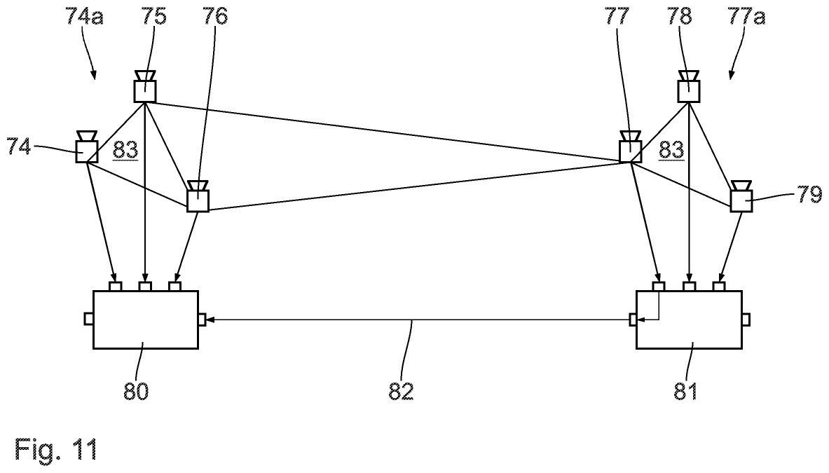

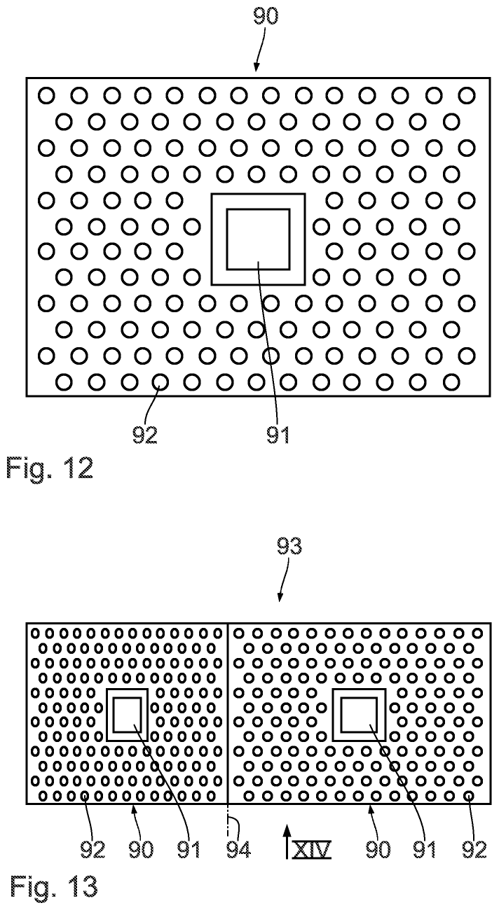

FIG. 12 shows another embodiment of a calibration panel 90 comprising a calibration surface having calibration structures, which calibration surface in turn can be used as a main calibration surface and/or as an additional calibration surface instead of the calibration surfaces explained above in the calibration apparatus 1 and/or in the system 41. The calibration panel 90 has a central pattern element 91, which can be designed in the manner of the pattern elements 20, 21 of the calibration panels described above.

A pattern or marker of the central pattern element 91 may be provided in coded form. Such a marker can be an augmented reality (AR) marker. A marker that can be used in this regard is known as an ArUco™ marker.

Another form of coding can also be used as an example of the central pattern element 91.

Furthermore, the calibration panel 90 has grid points 92 in the manner of the grid points 18 explained above. In addition to the grid points 91, colored pattern elements may also be provided, as explained above with reference to FIG. 6.

The grid points 92 are applied to the calibration panel 90 in the form of a hexagonal regular structure 12.

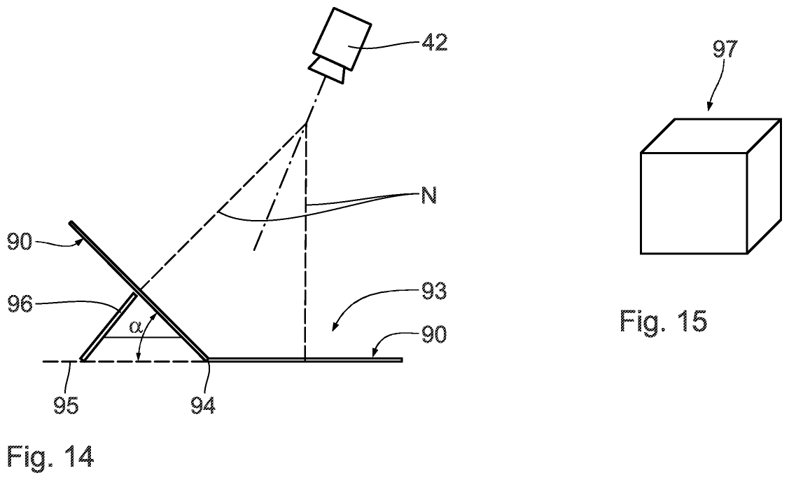

FIGS. 13 and 14 show an embodiment of a plate target 93 consisting of two interconnected calibration structure carrier components in the manner of calibration plates 90. The two calibration plates 90 of the plate target 93 are connected to each other via a hinge axis 94, which is perpendicular to the drawing plane of FIG. 14, and assume a known angle α to each other, which is 45° in the embodiment according to FIGS. 13 and 14. For this purpose, the calibration panel 90 on the left in FIGS. 13 and 14 is folded up or folded about the joint axis 94 with respect to a floor plane 95 (for example ax, ay). The folded-up calibration panel 90 is supported by a supporting structure 96, which determines the folding angle α.

Such a plate target comprising a plurality of individual plate-shaped calibration structure carrier components that are connected to each other via an angle is also referred to below as a folding target.

These respective calibration structure carrier components can have depth-staggered points (cf. grid points 92) as calibration structures. This allows a robust estimation of the free, i.e. not trapped, degrees of freedom of the respective arrangement of the plate targets.

Alternatively, the two interconnected calibration structure carrier components of such a plate target (folding target) can have a freely specifiable angle to each other.

FIG. 14 further illustrates an optimum viewing angle of a camera, which may be one of the cameras 2, 7 to 10, 30, 42 to 44 described above, using the example of the camera 42, relative to the arrangement of the plate target 93. Such an optimum viewing angle is provided when an image capture direction of the camera 42 runs along a bisector of an angle that is spanned by the two normals N of the calibration panel 90 of the plate target 93.

Such a plate target constructed from a plurality of connected calibration structure carrier components may also have more than two such plates, i.e. more than two calibration structure carrier components, so that a correspondingly larger number of relative angles of the individual calibration structure carrier components to one another results.

A plate-shaped calibration structure carrier component of such a folding target can lie flat on a floor structure, which reduces the number of degrees of freedom to be determined/estimated for the entire, connected plate target.

The calibration structure carrier components 46 to 49 can alternatively be constructed in a cube shape. The same calibration structure carrier component 46 to 49 can then be viewed from two sides with two of the cameras of the system 41 at an optimum viewing angle. For the optimum viewing angle, again what was explained above in connection with FIG. 14 applies.

Such a cube 97 (cf. FIG. 15) can be arranged flat on the floor structure.

Such a cube can be arranged along one of the coordinates and in particular along a given coordinate (x=x₀ or y=y₀).

In an alternative design of the calibration structure carrier components, these are configured to be “flying”, i.e. movable. This makes it possible to capture a very large number of images of such calibration structure carrier components, each of which is located at a different position. When such flying targets are used, the cameras 42 to 44 are fixed and record image sequences of at least one such flying target.

The necessary size of a target is determined by the distance to the camera and the resolution of the camera. If the cameras are very far above ground (e.g. 50 m on a crane), either the target must be very large or the targets are flown close to the cameras with drones.

Insofar as the calibration structure carrier components are designed as cubes, it may be permitted that the respective cube rotates during flight when using such calibration structure carrier components as flying targets.

The calibration structure carrier components in the manner of the carrier components 46 to 49 may alternatively or additionally serve multiple spectral channels, i.e. may behave differently in one predetermined spectral range than in another predetermined spectral range. For example, such a multispectral calibration structure carrier component, also referred to as a multispectral target, may have calibration structures in different colors that differ from each other. This enables, for example, simultaneous calibration of cameras that are designed in the same manner that are sensitive to different spectral ranges, e.g. RGB cameras on the one hand and IR cameras on the other hand.

In the event that the cameras 42 to 44 to be determined with regard to their relative position are very far away from the calibration structure carrier components, the calibration structure carrier components can alternatively be designed as single dots in the manner of the carrier components 46 to 49. In this case, a size of the respective single dots is not used for the relative position determination, but only the location of a single-dot center in space.

Such single-dot targets can be arranged on a plane.

The single-dot targets can be arranged to be distributed in the form of a rotation-invariant pattern.

Scaling information when using such single-dot targets can be obtained via a baseline length of the cameras and a corresponding triangulation.

A distance of the respective single-dot target to the respective camera 42 to 45 can also be determined with the aid of a laser rangefinder, i.e. a laser distance measurement device or distance sensor.

When using single-dot targets, the arrangement can also be such that a distance of two dots is known.

A main direction can be defined via a pattern of an arrangement of a plurality of such single dots. This in turn can be used to narrow down the degrees of freedom to be determined/estimated.

A target can consist of texture elements, from which an unambiguous assignment of the target in different cameras is obtained, if necessary scaling information if not otherwise available (base distance of the cameras, distance camera to target), and further unambiguously assignable features to increase accuracy. The filter algorithm can unambiguously determine the relative position of cameras from assigned features and thus also support the initial calibration.

The application of single-dot targets can also be used to determine a plane alignment.

A target can be composed of manually distributed panels, for example with a large dot. The panels can be distributed at any distance, ideally in a clear arrangement, on a flat floor and measured using laser rangefinders and thus serve as a (composite) target.

Instead of specific calibration structure carrier components, key features can also be used. Corresponding key features are discussed in the technical article “Image Matching Using SIFT, SURF, BRIEF and ORB: Performance Comparison For Distorted Images” by E. Karami et al., arXiv: 17010.02726. These are features that can be found and matched from different positions with different cameras that have a comparable lens.

Hereby, the distance of the cameras 42 to 44 from each other and/or the distance of each of the cameras 42 to 44 from at least one of the key features can be used.

Various relative movements and alignment variants are possible when determining the position of the camera entrance pupils:

The supporting frame 45 may move in the manner of a vehicle, wherein the cameras 42 to 44 remain fixed relative to each other.

The targets can be arranged in particular along a manufacturing line, for example along a manufacturing assembly line. Here, all viewing directions that are relevant for the respective assembly line run can be considered.

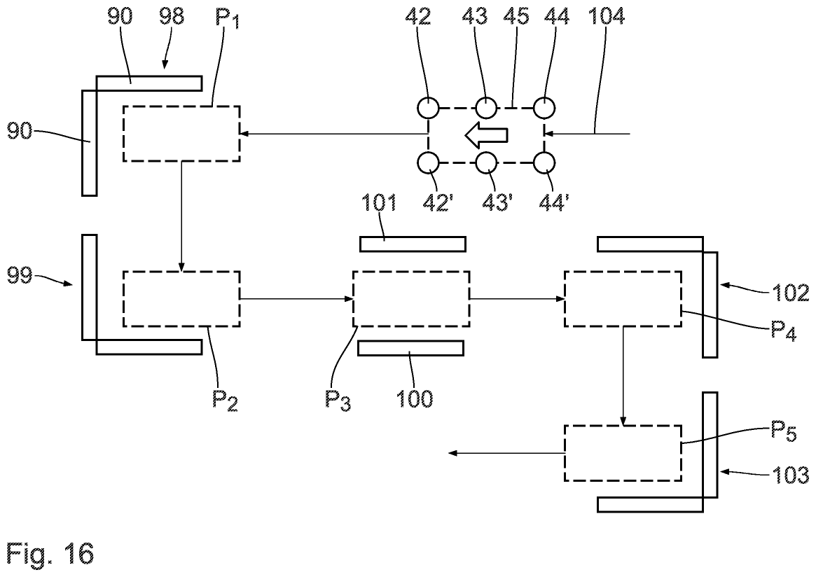

FIG. 16 shows an example of such an arrangement of plate targets 98 to 103 which are arranged along a manufacturing line 104.

The plate targets 99, 102 and 103 are designed according to the plate target 93.

The plate targets 100, 101 are individual calibration panels, for example in the manner of calibration panel 90.

The supporting frame 45 in the form of a chassis carries six cameras 42 to 44, 42′ to 44′, whose relative positions to each other, in particular their entrance pupil center positions relative to each other, are to be determined.

FIG. 16 shows a total of five manufacturing line positions P₁ to P₅ that are occupied in succession by the supporting frame 45.

In position P₁ the plate target 98, comprising two calibration panels 90 having a folding angle of 90° to each other, is used to determine the position of the camera 42 (in FIG. 16 at the top left of the supporting frame 45).

In the following position P₂ the plate target 99, which is again assigned to this position P₃, is used to determine the position of the camera 42′ (in FIG. 16 at the bottom left of the supporting frame 45).

In the following position P₃ the plate targets 100, 101 are used to determine the position of the cameras 43′ (in FIG. 16 at the bottom center of the supporting frame 45) and 43 (in FIG. 16 at the top center of the supporting frame 45).

In position P₄ the plate target 102 is used to determine the position of the camera 44 (in FIG. 16 on the top right of the supporting frame 45).

In the following position P₅ the plate target 103 is used to determine the position of the camera 44′ (in FIG. 16 on the lower right of the supporting frame 45).

After passing through the positions P₁ to P₅, the positions of all six cameras 42 to 44, 42′ to 44′ on the supporting frame 45 are determined and thus also the relative positions of these cameras to each other.

In addition, floor targets placed on the respective floor structure can also be used, which, as already explained above, reduces the number of degrees of freedom to be determined/estimated.

An alignment of the targets can be performed on the basis of nominal, i.e. predefined arrangements, which are known, for example, on CAD data of a basic structure within which the targets are accommodated.

Alignment can be carried out at the following structures:
at fixed cameras that are nominally determined with regard to their location;
at fixed targets that are nominally specified in terms of their location;
at the nominal fixed cameras and targets;
at selected targets;
at selected cameras;
at linear movements of targets;
at linear movement of the vehicle (manufacturing line).

With the help of the system 41, an intrinsic camera calibration can be performed in addition to an extrinsic calibration. This can be done within a motor vehicle manufacturing line, for example, if the cameras 42 to 44 belong to a vehicle to be manufactured. In this case, the intrinsic camera calibration may be performed without using a calibration apparatus corresponding to that explained above with reference to FIGS. 1 to 4. When using the system 41 for intrinsic camera calibration, the vehicle in the current manufacturing state is stopped in front of a dense arrangement of targets corresponding to the calibration structures explained above and a CAP grid, i.e. one of the main calibration surfaces in the manner of calibration surfaces 15 to 17, is measured.

A robot 1 temporarily guides an AUX grid, i.e. one of the additional calibration surfaces, in the manner of calibration surfaces 22 to 24, in front of the cameras 42 to 44, 42′ to 44′.

A robot 2 guides an additional, movable reference camera of the type of the reference camera 30 of the calibration apparatus 1 described above for viewing the CAP grids and/or the AUX grids.

For calibration, the CAP grid on the one hand and the AUX grid on the other hand must be measured from at least one camera position of the cameras 42 to 44, 42′ to 44′ and then from a second camera position of the cameras 42 to 44, 42′ to 44′.

A positioning sequence can be, for example: In the first camera position, the CAP grid is measured. Then robot 1 supplies the AUX grid. The AUX grid is then measured in the first camera position. Robot 2 then moves the camera from the first camera position to the second camera position. The AUX grid is then measured in the second camera position. Robot 1 then moves the AUX grid away and the CAP grid is measured in the second camera position.

A plurality of cameras can also be mounted on the robot 2.

In such an intrinsic calibration by means of the system 41, a plurality of stops of the carrier 45, i.e. the vehicle to be manufactured, can be made at a plurality of suitable positions within the manufacturing line.

The system 41 may have a plurality of movable reference cameras. These reference cameras can view the CAP grids and/or the AUX grids from at least two directions.

The movable reference camera is used to calibrate the main calibration surfaces according to what has been explained above in connection with the calibration apparatus.

A plurality of cameras to be calibrated, in particular a camera bundle that is mounted on a common camera carrier, can be calibrated together with the aid of the intrinsic calibration method described above and also using the extrinsic camera calibration method described above.

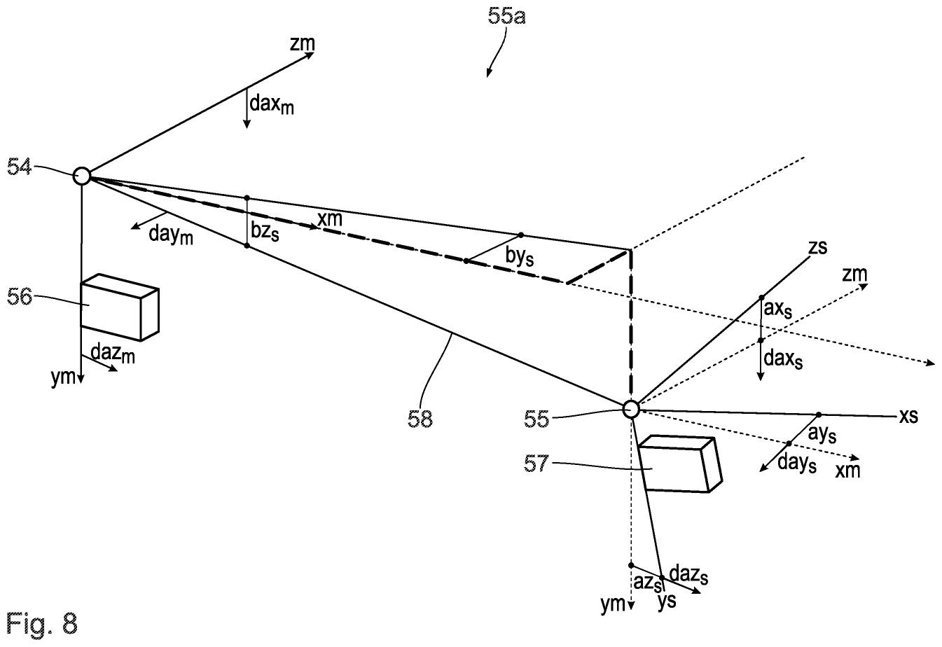

With reference to FIGS. 8 to 10, a method for capturing three-dimensional images with the aid of a stereo camera 55a having two cameras 54, 55 is described below. These cameras 54 to 55 may have been calibrated in a preparatory step with the aid of the calibration apparatus 1 and also measured with regard to their relative position with the aid of the system 41.

The camera 54 shown on the left in FIG. 8 is used as the master camera to define a master coordinate system xm, ym and zm. Zm is the image capture direction of the master camera 54. The second camera 55 shown on the right in FIG. 8 is then the slave camera.

The master camera 54 is permanently connected to an inertial master measuring unit 56 (IMU), which can be designed as a rotation rate sensor, in particular in the form of a micro-electro-mechanical system (MEMS). The master measuring unit 56 measures angular changes of a pitch angle daxₘ, a yaw angle dayₘ and a roll angle dazₘ of the master camera 54 and thus allows to monitor position deviations of the master coordinate system xm, ym, zm in real time. A time constant of this real-time position deviation detection can be better than 500 ms, can be better than 200 ms and can also be better than 100 ms.

The slave camera 55 is also firmly connected to an associated inertial slave measuring unit 57, via which angular changes of a pitch angle daxₛ a yaw angle dayₛ and a roll angle dazₛ of the slave camera 55 can be detected in real time, so that relative changes of the slave coordinate system xs, ys, zs with respect to the master coordinate system xm, ym, zm can again be detected in real time in each case. Relative movements of the cameras 54, 55 of the stereo camera 55a with respect to each other can be detected in real time via the measuring units 56, 57 and included in the method for capturing three-dimensional images. The measuring units 56, 57 can be used to predict a change in relative position of the cameras 54, 55 with respect to each other. Image processing performed as part of the three-dimensional image capture can then further improve this prediction as to the relative position. Even if, for example, due to a supporting frame on which the stereo camera 54a is mounted moving on an uneven surface, the cameras 54, 55 continuously move against each other, the result of the three-dimensional image capture is still stable.

A line connecting the centers of the entrance pupils of the cameras 54, 55 is marked 58 in FIG. 8 and represents the baseline of the stereo camera 55a.

In the method for capturing three-dimensional images, the following angles are captured that are relevant to the positional relationship of the slave camera 55 to the master camera 54:
the angle byₛ, i.e. a tilting of a plane, through which the baseline 58 passes, which is perpendicular to the plane xmzm, to the plane xmym about the tilting axis ym;
bzₛ: a tilting of the baseline 58 to the plane xmzm about a tilting axis that is parallel to the slave coordinate axis zs, corresponding to the tilting byₛ;
axₛ: a tilting of the slave coordinate axis zs, i.e. the image capture direction of the slave camera 55, relative to the plane xmzm about the slave coordinate axis xs;
ayₛ: a tilting of the slave coordinate axis xs relative to the master plane xmym about the slave coordinate axis ys, corresponding to the tilting axₛ as well as
azₛ: a tilting of the slave coordinate axis ys relative to the master coordinate plane ymzm about the slave coordinate axis zs, corresponding to the tilts axₛ, ayₛ.

The following procedure is used for capturing three-dimensional images with the aid of the two cameras 54, 55, taking into account, on the one hand, these angles byₛ, bzₛ, axₛ, ayₛ, azₛ including the angular changes daxₘ, dayₘ, dazₘ, daxₛ, dayₛ, dazₛ detected by the measuring units 56, 57:

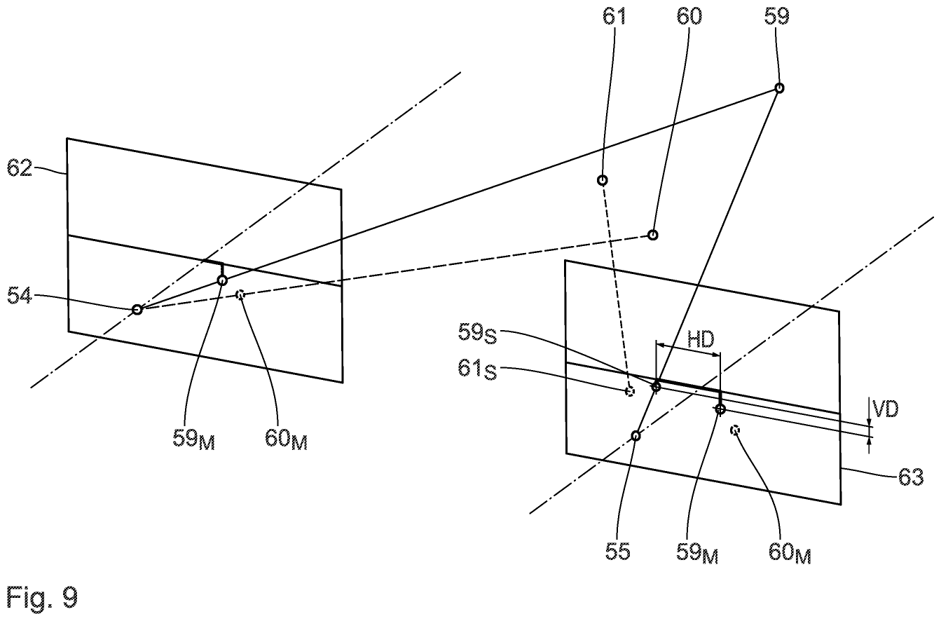

First, an image of a three-dimensional scene with scene objects 59, 60, 61 (cf. FIG. 9) is captured simultaneously by the two cameras 54, 55 of the stereo camera. This image capture of the images 62, 63 is done simultaneously for both cameras 54, 55 in a capture step 64 (cf. FIG. 10).

FIG. 9 schematically shows the respective image 62, 63 of the cameras 54 and 55.

The image of scene object 59 is shown in image 62 of master camera 54 at 59_{M}, and the image of scene object 60 is shown at 60_{M}.

The imaging of scene object 59 is shown in image 63 of the slave camera 55 at 59_{S}. The imaging of scene object 61 is shown in image 63 of the slave camera 55 at 61_{S}. In addition, the imagings 59_{M}, 60_{M} of the master camera 54 can also be found in image 63 of the slave camera 55 at the corresponding x, y coordinates of the image frame.

A y-deviation of the imaging positions 59_{M}, 59_{S} is called disparity perpendicular to the epipolar line of the respective camera or vertical disparity VD. Correspondingly, an x-deviation of the imaging positions 59_{M}, 59_{S} of the scene object 59 is called disparity along the epipolar line or horizontal disparity HD. In this context, reference is made to the known terminology on epipolar geometry. The parameter “center of the camera entrance pupil” is called “projection center” in this terminology.

The two imagings 60_{M}, 61_{S} show the same signature in the images 62, 63, thus are represented with the same imaging pattern in the images 62, 63, but actually originate from the two scene objects 60 and 61, which are different within the three-dimensional scene.

The characteristic signatures of the scene objects 59 to 61 in the images are now determined separately for each of the two cameras 54, 55 in a determination step 65 (cf. FIG. 10).

The signatures determined in step 65 are summarized in a signature list in each case and, in an assignment step 66, the signatures of the captured images 62, 63 determined in step 65 are assigned in pairs. Identical signatures are thus assigned to each other with regard to the captured scene objects.

Depending on the captured three-dimensional scene, the result of the assignment step 66 may be a very high number of assigned signatures, for example several tens of thousands of assigned signatures and correspondingly several tens of thousands of determined characteristic position deviations.

In a further determination step 67, characteristic position deviations of the assigned signature pairs from each other are now determined, for example the vertical and horizontal disparities VD, HD.

For example, the vertical disparity VD determined in each case is added up square for all assigned signature pairs. By varying the angle parameters byₛ, bzₛ, axₛ, ayₛ, azₛ described above in connection with FIG. 8, this sum of squares can then be minimized. This sum of squares depends on these angles explained above in connection with FIG. 8.

In a subsequent filtering step 68, the determined position deviations are then filtered to select assigned signature pairs that are more likely to belong to the same scene object 59 to 61, using a filter algorithm. The simplest variant of such a filter algorithm is a selection by comparison with a predefined tolerance value, wherein only those signature pairs pass the filter for which the sum of squares is smaller than the predefined tolerance value. This default tolerance value can, for example, be increased until the number of selected signature pairs is smaller than a predefined limit value as a result of the filtering.

As soon as, as a result of the filtering, a number of selected signature pairs is smaller than a predetermined limit value, for example smaller than one tenth of the signatures originally assigned in pairs or absolutely smaller than five thousand signature pairs, for example, a triangulation calculation for determining depth data for the respective scene objects 59 to 61 takes place in a step 69. In addition to the number of selected signature pairs, a default tolerance value for the sum of squares of characteristic position deviations of the associated signature pairs, for example of the vertical disparity VD, can also serve as a termination criterion, in accordance with what has been explained above. A standard deviation of the characteristic position deviation, for example of the vertical disparity VD, can also be used as a termination criterion.

As a result of this triangulation calculation, a 3D data map of the captured scene objects 59 to 61 within the captured image of the three-dimensional scene can be created and output as a result in a creation and output step 70.

If the filtering step 68 shows that the number of selected signature pairs is still greater than the specified limit value, a determination step 71 first determines angular correction values between the various selected assigned signature pairs to check whether imaged raw objects that belong to the various selected assigned signature pairs can be arranged in the correct position relative to one another within the three-dimensional scene. For this purpose, the angles described above in connection with FIG. 8 are used, wherein these angles are available corrected in real time due to the measurement monitoring via the measuring units 56, 57.

Based on a compensation calculation carried out in the determination step 71, the scene objects 60, 61, for example, can then be distinguished from each other in the images 62, 63 despite their identical signatures 60_{M}, 61_{S}, so that a correspondingly assigned signature pair can be discarded as a misassignment, so that the number of selected signature pairs is reduced accordingly.

After the angle correction has been performed, a comparison step 72 is carried out to compare the angular correction values determined for the signature pairs with a predefined correction value. If the angular values of the signature pairs as a result of the comparison step 72 deviate from each other more than the predetermined correction value, the filter algorithm used in the filtering step 68 is adapted in an adaptation step 73 in such a manner that, after filtering with the adapted filter algorithm, a number of selected signature pairs results which is smaller than the number which resulted in the previous filtering step 68. This adjustment can be done by eliminating signature pairs that differ in their disparities by more than a predetermined limit value. Also, a comparison benchmark, from when the signatures of a potential signature pair are assessed to be the equal and thus assignable, can be set more critically in the adjustment 73.

This sequence of steps 73, 68, 71 and 72 is then carried out until it is found that the angular correction values of the remaining assigned signature pairs deviate from each other by no more than the specified correction value. The triangulation calculation is then carried out again in step 69, wherein the angular correction values of the selected signature pairs can be included, and the results obtained are generated and output, in particular in the form of a 3D data map.

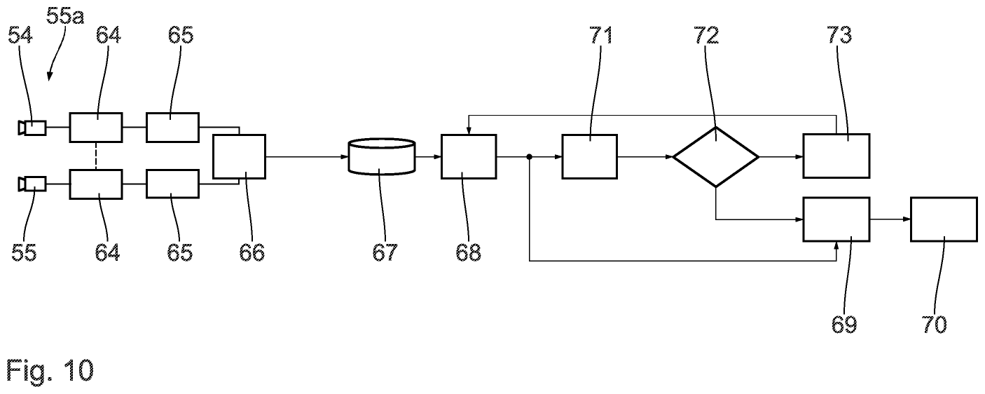

FIG. 11 illustrates a method for producing a redundant image of a measurement object. For this purpose, a plurality of cameras are linked together whose entrance pupil centers define a camera arrangement plane. FIG. 11 shows two groups of three cameras 74 to 76 each, on the one hand (group 74a), and 77, 78, 79, on the other hand (group 77a). The groups 74a on the one hand and 77a on the other hand each have an associated data processing unit 80, 81 for processing and evaluating the image data acquired by the associated cameras. The two data processing units 80, 81 are in signal connection with each other via a signal line 82.

To capture a three-dimensional scene, for example, the cameras 74 to 76 of the group 74a can be interconnected so that, for example, a 3D capture of this three-dimensional scene is made possible via an image capture method explained above in connection with FIGS. 8 to 10. To produce an additional redundancy of this three-dimensional image capture, the image capture result of, for example, the camera 77 of the further group 77a can be used, which is provided to the data processing unit 80 of the group 74a via the data processing unit 81 of the group 77a and the signal line 82. Due to the spatial distance of the camera 77 to the cameras 74 to 76 of the group 74a, there is a significantly different viewing angle when imaging the three-dimensional scene, which improves the redundancy of the three-dimensional image capture.

A camera arrangement plane 83 that is defined by the cameras 74 to 76 of group 74a or the cameras 77 to 79 of group 77a is schematically indicated in FIG. 11 and is located at an angle to the drawing plane of FIG. 11.

Three-dimensional image capture using the cameras of exactly one group 74a, 77a is also referred to as intra-image capture. A three-dimensional image capture involving the cameras of at least two groups is also called inter-image capture.

Triangulation can be performed, for example, with the stereo arrangements of the cameras 78, 79, the cameras 79, 77 and the cameras 77, 78 independently in each case. The triangulation points of these three arrangements must coincide in each case.

A camera group in the manner of groups 74a, 77a can be arranged in the form of a triangle, in particular in the form of an isosceles triangle. An arrangement of six cameras in the form of a hexagon is also possible.

Compared to the distance between the cameras of one group 74a, 77a, the cameras of the other group are at least a factor of 2 further away. A distance between the cameras 76 and 77 is therefore at least twice the distance between the cameras 75 and 76 or the cameras 74 and 76. This distance factor can also be greater and can, for example, be greater than 3, can be greater than 4, can be greater than 5 and can also be greater than 10. A camera close range covered by the respective group 74a, 77a can, for example, be in the range between 80 cm and 2.5 m. By adding at least one camera of the respective other group, a far range can also be captured by the image capture apparatus beyond the near range limit.

1. An apparatus (1) for calibrating a three-dimensional position of a center of an entrance pupil of a camera (2),
comprising a mount (4) for holding the camera (2) in such a manner that the camera (2) captures a predetermined calibration field of view (5),
comprising at least two stationary reference cameras (7 to 10) for recording the calibration field of view (5) from different directions (11 to 14),
comprising at least one stationary main calibration surface (15 to 17) having stationary main calibration structures (18 to 21) that are arranged in the calibration field of view (5),
comprising at least one additional calibration surface (22 to 24) which has additional calibration structures (25) which driven to be displaceable between
a neutral position in which the additional calibration surface (22 to 24) is arranged outside the field of view (5), and
an operating position in which the additional calibration surface (22 to 24) is arranged within the field of view (5),
via a calibration surface displacement drive (27),
comprising an evaluation unit (29) for processing recorded camera data of the camera (2) to be calibrated and of the reference cameras (7 to 10) and status parameters of the apparatus (1).

2. The apparatus according to claim 1, comprising at least one further reference camera (30), which is movable relative to the mount (4), for recording the calibration field of view (5), which is driven to be displaceable between
a first field of view recording position and
at least one further field-of-view recording position that differs from the first field-of-view recording position in an image capture direction (32),
via a camera displacement drive (31).

3. The apparatus according to claim 1, wherein the additional calibration structures (25) of the respective additional calibration surface (22 to 24) are provided in a 3D arrangement that deviates from a flat surface.

4. The apparatus according to claim 1, wherein the main calibration structures (18 to 21) are arranged in a main calibration structure main plane (xy) and additionally in a main calibration structure angular plane (yz), wherein the main calibration structure angular plane is arranged at an angle greater than 5° to the main calibration structure main plane.

5. A method for calibrating a three-dimensional position of a center of an entrance pupil of a camera (2) by means of the apparatus (1) as in claim 1, comprising the steps of:
holding the camera to be calibrated (2) in the mount (4),
capturing the stationary main calibration surface (15 to 17) with the camera (2) to be calibrated and the reference cameras (7 to 10; 7 to 10, 30) with the additional calibration surface (22 to 24) in the neutral position,
displacing the additional calibration surface (22 to 24) between the neutral position and the operating position with the calibration surface displacement drive (27),
capturing the additional calibration structures (25) with the camera (2) to be calibrated and the reference cameras (7 to 10; 7 to 10, 30) with the additional calibration surface (22 to 24) in the operating position,
evaluating the recorded image data of the camera (2) to be calibrated and the reference cameras (7 to 10; 7 to 10, 30) with the evaluation unit (29).

6. The method according to claim 5, for calibrating the three-dimensional position of the center of the entrance pupil of the camera by means of the apparatus further comprising at least one further reference camera (30), which is movable relative to the mount (4), for recording the calibration field of view (5), which is driven to be displaceable between
a first field of view recording position and
at least one further field-of-view recording position that differs from the first field-of-view recording position in an image capture direction (32),
via a camera displacement drive (31),
comprising the following further steps:
capturing at least one of the main calibration surface (15 to 17) and the additional calibration surface (22 to 24) with the movable reference camera (30) in the first field of view recording position,
displacing the movable reference camera (30) with the camera displacement drive (31),
capturing at least one of the main calibration surface (15 to 17) and the additional calibration surface (22 to 24) with the movable reference camera (30) in the further field of view recording position,
evaluating recorded image data of the movable reference camera (30) with an evaluation unit (29).

7. A system (41) for determining relative positions of centers of entrance pupils of at least two cameras (42 to 44) which are mounted on a common supporting frame (45) with respect to each other
comprising a plurality of calibration structure carrier components (46 to 49) comprising calibration structures (18 to 21) that can be arranged around the supporting frame (45) such that each of the cameras (42 to 44) detects at least calibration structures (18 to 21) of two of the calibration structure carrier components (46 to 49), wherein the arrangement of the calibration structure carrier components (46 to 49) is such that at least one of the calibration structures (18 to 21) of one and the same calibration structure carrier component (46 to 49) is captured by two cameras,
comprising an evaluation unit (53) for processing recorded camera data of the cameras (42 to 44).

8. A method for determining relative positions of centers of entrance pupils of at least two cameras (42 to 44), comprising the following steps
mounting the cameras (42 to 44) on a common supporting frame (45),
arranging calibration structure carrier components (46 to 49) as a group of calibration structure carrier components (46 to 49) around the supporting frame (45),
capturing the calibration structure carrier components (46 to 49) that are located in a field of view of the cameras (42 to 44) in a predetermined relative position of the supporting frame (45) to the group of calibration structure carrier components (46 to 49),
evaluating recorded image data of the cameras (42 to 44) with an evaluation unit (53).

9. The method according to claim 8, comprising the following further steps:
displacing the supporting frame (45) in such a manner that at least one of the cameras (42 to 44) captures a calibration structure carrier component (46 to 49) which has not been previously detected by this camera (42 to 44),
repeating the capturing and displacement until each of the cameras (42 to 44) has captured at least calibration structures (18 to 21) of two of the calibration structure carrier components (46 to 49), wherein calibration structures (18 to 21) of at least one of the calibration structure carrier components (46 to 49) have been captured by two cameras (42 to 44).

10. The method according to claim 8, wherein the calibration structures (18 to 21) of one (46) of the calibration structure carrier components (46 to 49) are used as master structures for specifying a coordinate system (xyz) of the relative positions to be determined.
